(19) United States
(12) Patent Application Publication
(10) Pub. No.: US 2009/0089327 A1
(43) Pub. Date: Apr. 2, 2009

(54) SYSTEM AND METHOD FOR SOCIAL PROGRAMMING OF MEDIA SOURCES

(76) Inventors: Chris Kalaboukis, Los Gatos, CA (US); Todd Beaupre, Los Angeles, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 11/864,622

(22) Filed: Sep. 28, 2007

(51) Int. Cl. G06F 17/30; G06F 3/048

(52) U.S. Cl. 707/104.1; 715/840; 707/E17.001

(57) ABSTRACT

A method, system and user interface are provided for building and programming an online media (radio or TV) station based on collaboration by the station's users. The method includes creating an initial playlist for an online media station; creating a set of recommended media content items distinct from the initial playlist; aggregating user input regarding the recommended media content items; and generating a new playlist in accordance with the aggregated input. The user input regarding a given item of media content may include a positive vote or a negative vote. Each item added to the playlist after the initial playlist is voted on by the users, so that each item of the new playlist has an aggregated positive vote greater than a predetermined vote threshold.

### FIELD OF THE DISCLOSURE

This disclosure relates to programming of online media (audio and video) stations, and specifically to a system and method for building and programming a station based on collaboration by the station's users.

### BACKGROUND OF THE DISCLOSURE

Traditional radio and television stations are programmed by station administrators, not by their listeners or viewers. Similarly, conventional online media stations are programmed by editors and programmers, not by their users. A user logged on to a typical online station will hear or see the selections (items of content) on that station's playlist, which generally conform to the genre or format of that station. A user may request that a certain selection be played, but otherwise has little influence on the programming of the station.

### SUMMARY OF THE DISCLOSURE

The present disclosure provides a system and method for collaboratively building online radio and television stations based on their users' explicit and implicit actions. According to an aspect of the disclosure, this is done by creating an initial playlist for an online media station; creating a set of recommended media content items distinct from the initial playlist; aggregating user input regarding the recommended media content items; and generating a new playlist in accordance with the aggregated input. The user input regarding a given item of media content may include a positive vote or a negative vote. Each item added to the playlist after the initial playlist is voted on by the users, so that each item of the new playlist has an aggregated positive vote greater than a predetermined vote threshold.

According to another aspect of the disclosure, a system is provided which includes a server configured to create an initial playlist for an online media station; create a set of recommended media content items distinct from the initial playlist, using a recommendation engine and a database of media content items; aggregate user input regarding the recommended media content items; and generate a new playlist in accordance with the aggregated input.

According to a further aspect of the disclosure, a computer-readable medium is provided which has stored thereon instructions for performing the method outlined just above.

According to still another aspect of the disclosure, a user interface, related to an online media station, is provided which includes a first area for displaying identifiers for a set of recommended media content items, and a second area including buttons for user input regarding the recommended media content items; the set of recommended media content items is distinct from an initial playlist of the station, and the buttons are effective to record positive votes and negative votes regarding the media content items.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1A is a schematic illustration of a computing device of a user of an online radio or television station, with a list of possible selections displayed to the user.

FIG. 1B is a schematic illustration of a system for delivering media content to the user via an online station.

FIG. 2 illustrates a list of possible selections displayed with buttons for user input, in accordance with an embodiment of the disclosure.

FIG. 3 is a flowchart illustrating a process for generating a new playlist from a user's point of view, in accordance with an embodiment of the disclosure.

FIG. 4 is a flowchart showing details of a process for building a new playlist for a station according to user preferences, in accordance with an embodiment of the disclosure.

FIG. 5 illustrates a list displayed with buttons as in FIG. 2, with the addition of a button for creating a station, in accordance with an embodiment of the disclosure.

FIG. 6 is a flowchart illustrating a process for generating a playlist for a station based on a particular topic of interest to the members of a group, in accordance with an embodiment of the disclosure.

FIG. 7 is a flowchart illustrating a process wherein a programmer intervenes in a process of users' editing a station playlist, in accordance with an embodiment of the disclosure.

### DETAILED DESCRIPTION

In the following descriptions, the term “station” may refer to either an online audio source (e.g. a radio station), or an online video source (e.g. a television station).

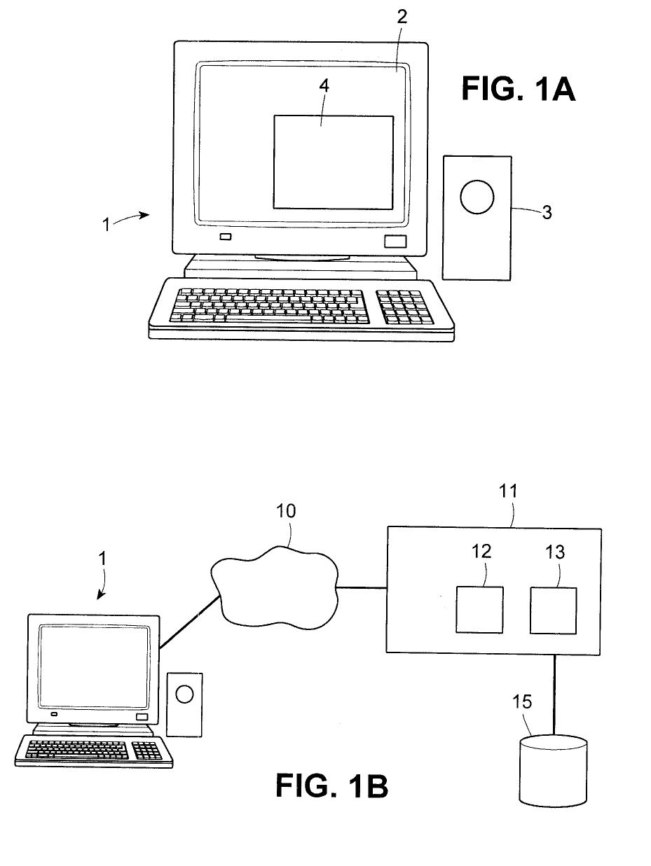

FIG. 1A schematically illustrates a user's computing device 1 with a video display 2 and an audio speaker 3 for listening to an online radio station. In an embodiment of the disclosure, a user logged on to the station hears a track on the playlist for the station, and is presented with a list 4 of recommended content items (audio tracks) similar to the track currently being played. The list is displayed alongside a set of buttons (more generally, actionable areas of the display) so that the user may make input regarding content items on the list.

The user device 1 is connected via a network 10 (typically the Internet) to a server 11 which has software 12 for administering the online station, as shown schematically in FIG. 1B. In particular, the software 12 maintains the playlist for the station, and aggregates and tabulates user input regarding selections displayed on the list 4. It will be appreciated that server 11 may maintain a number of stations at the same time. The server also includes, or has access to, a recommendation engine 13 which searches a database 15 of media content and generates the list of recommended tracks.

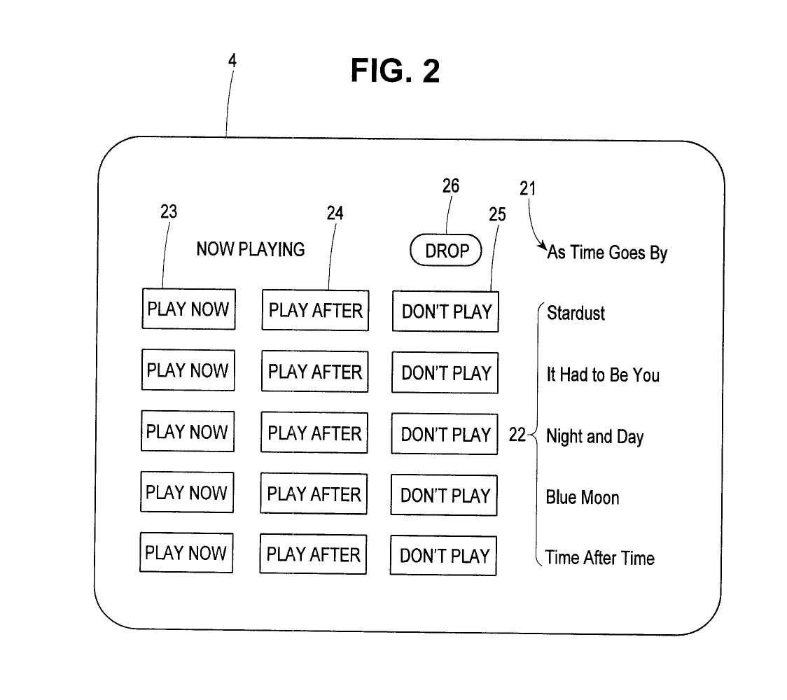

A more detailed view of the displayed list 4 is shown in FIG. 2. The recommendation engine searches the database of tracks and extracts a given number of content items 22 (e.g. five, as shown in FIG. 2) for display. The title of the track 21 currently playing is labeled “Now Playing,” with a button 26 alongside it labeled “Drop.” Beside each title of the recommended tracks 22 are buttons 23-25, labeled “Play Now,” “Play After” and “Don't Play” respectively. The tracks 22 listed are generally not on the playlist for the station, but are presented to the user to test the user's preferences. The display 4, including buttons 23-26, thus serves as a user interface for inputting preferences regarding the list of recommended content items and for modifying the playlist, as detailed below.

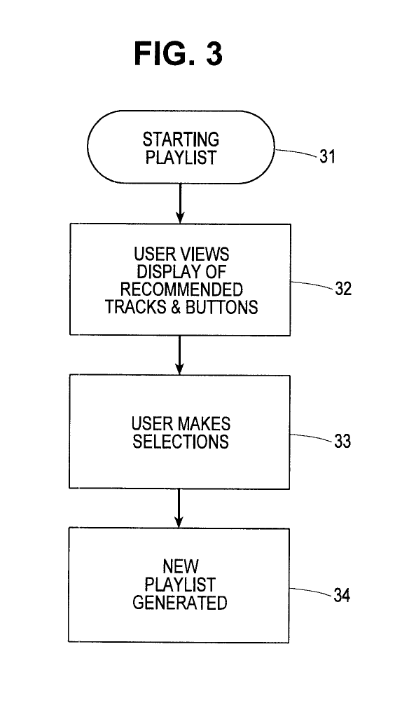

A flowchart illustrating a basic process for programming a station, from a user's point of view, is shown in FIG. 3. The playlist for a radio station, for example, is initially generated by an editor or programmer in accordance with a particular genre of music corresponding to the selected format for the station (step 31). As users listen to the station, the recommendation engine causes a list of tracks to be displayed which are similar to the track which is currently playing, along with buttons for recording the users' preferences (step 32). A user need not click on any of the buttons, in which case the station will simply continue to play its playlist. As users record their preferences by clicking on one or more buttons (step 33), a new playlist will be generated accordingly (step 34).

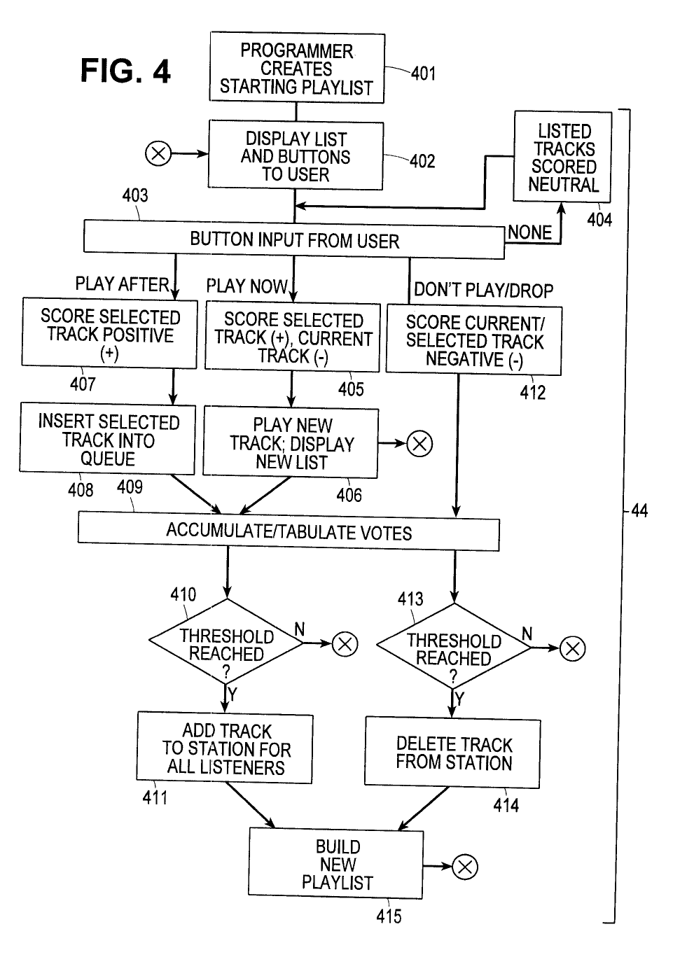

Details of a process for generating a station playlist, in accordance with input received from users, are shown in the flowchart of FIG. 4. A programmer for the station creates the starting playlist (step 401). The currently playing track 21, the list of recommended tracks 22, and buttons 23-25 are displayed to each user (step 402), as shown for example in FIG. 2. Each user expresses his preferences by clicking on the buttons (step 403), thereby establishing a score (or level of preference) for each track listed on the display. If the user ignores the recommended tracks 22 and makes no input via the buttons (step 404), then the listed tracks 22 are scored neutral in relation to the genre of the radio station. If the user clicks on the “Play Now” button 23 corresponding to a recommended track (step 405), then the track 21 presently playing is scored negative (has a negative vote associated with the track) and the new track is played (step 406). If the user clicks the “Play After” button 24 for a recommended track (step 407), then that selected track is scored positive (has a positive vote associated with the track) and inserted into the playlist prior to the next queued track (step 408). If enough users who are listening to the same station also click the “Play After” button to play that track next, then the number of positive votes for that track will further increase.

It should be noted that a user who clicks the “Play Now” button 23 for a listed track 22 will hear that track instead of the presently playing track 21. The display for that user will be updated by labeling the new track “Now Playing” and presenting a new set of recommended tracks (step 402). Meanwhile, a user who has not clicked on any button will continue to listen to track 21. Similarly, a user who clicks the “Play After” button 24 for a listed track 22 will hear that track after the current track concludes, instead of the next track on the playlist. In general, different users on the same radio station may hear different tracks, according to their individual preferences.

The button clicks (positive and negative votes) from all the users are aggregated and tabulated (step 409). Once the number of “Play Now” or “Play After” clicks reaches a certain threshold (step 4101, then the track is automatically added to the radio station playlist for all users who subsequently log on to the station (step 411).

A user also has the option to vote to “Drop” the track currently playing from the station playlist, by clicking on the “Drop” button 26, or vote to block one of the recommended tracks from being played by clicking on the “Don't Play” button 25. That track is then scored negative (step 412). The negative votes are also aggregated and tabulated, and if enough “Drop/Don't Play” votes are collected (step 413), then the track is deleted from the station playlist (step 414). The accumulated additions to and deletions from the original, programmer-created playlist thus result in a new, user-created playlist for the station (step 415).

A station therefore need only be seeded initially by a programmer created playlist, after which the station playlist will continuously be updated based on the preferences of the users listening to the station. The recording of user preferences, aggregating and tabulating users' votes, and resultant updating of the playlist may be viewed as a user editing process 44 for the playlist, in which all of the users collaborate. Alternatively (or if there are not enough users expressing preferences to change the playlist automatically), the programmer for the station may retain control of the playlist, with the users' input providing feedback in real time.

In another embodiment, a playlist for an online TV station may be edited by the viewers of the station. As a consumer watches the station, the recommendation engine presents other videos as alternatives to the one currently playing. For each video listed by the recommendation engine, the user may choose “View Now,” “View After,” or “Don't View” by clicking on the appropriate button. Clicking on “View Now” will replace the currently playing video and add to the score for the new video. Clicking on “View After” will insert the new video into the next slot on the playlist, between the current video and the video scheduled to follow.

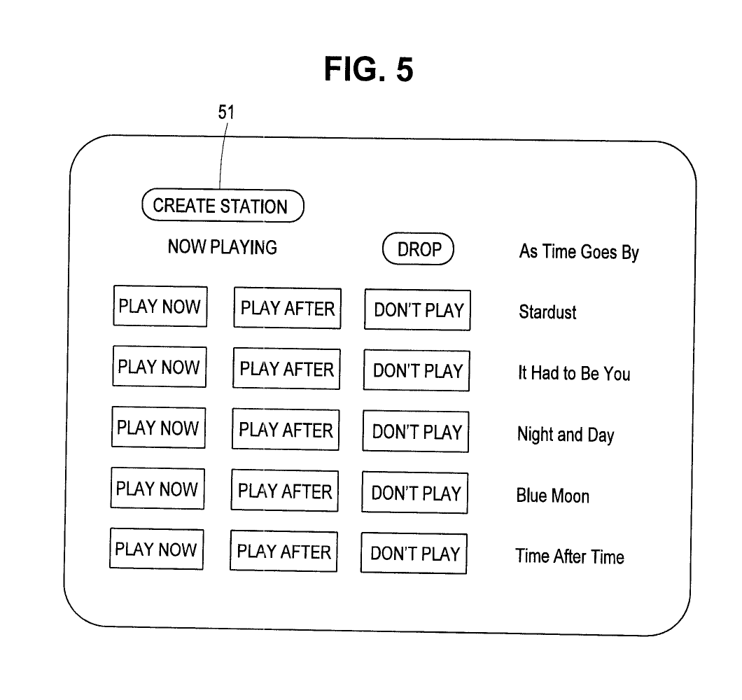

In a further embodiment (see FIG. 5), a user listening to a track or watching a video may click a “Create Station” button 51. Clicking this button invokes the recommendation engine and causes a list of tracks (or videos) to be generated based on the selection currently playing. This list is then established as the playlist for a new, personalized station. The user may then use that list as the seed playlist in an editing process as described above.

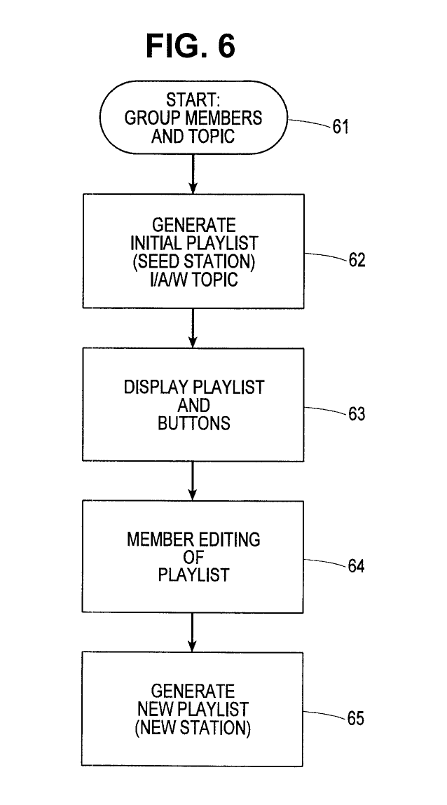

In still another embodiment, a station may be created for a group of users interested in a particular topic. A process for creating such a station is shown schematically in FIG. 6. An online community, such as a Yahoo!® (group, is sorted and organized by topic (step 61). An online TV station, for example, with videos all relating to one topic (a “seed station”) is created with an initial playlist generated by a programmer (step 62). Each member of the group is then presented with the playlist, with buttons for expressing preferences as described above (step 63), so that every member of the group can participate in editing the playlist (step 64). While any of the group members are watching the station, they have the ability to click on “View Now,” “View After” and/or “Don't View” buttons. As the group members use the station, a more relevant and targeted playlist for the station is generated (step 65). In an embodiment, this topic-specific station may be viewed by non-members of the group, but only group members have the ability to edit the station playlist.

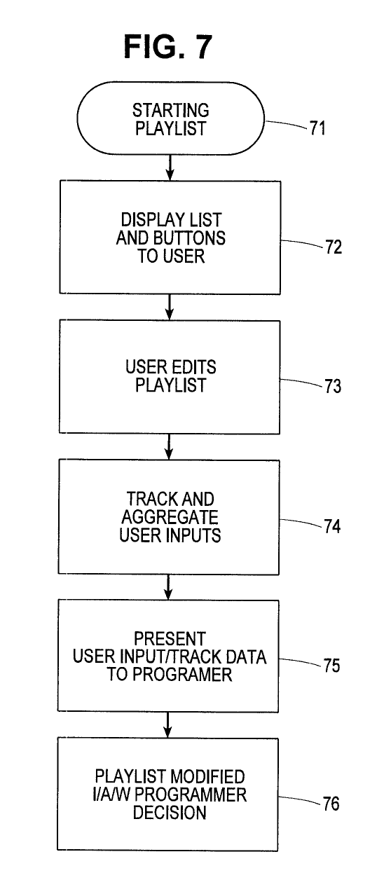

In a further embodiment, information regarding a user is communicated to the programmer of a station, and the programmer may intervene to modify a playlist edited by one or more users. A process in accordance with this embodiment is illustrated schematically in FIG. 7. The programmer creates an initial playlist (step 71), and a list of recommended media content items and buttons is presented to the user in a user interface (step 72) as described above. A user has the opportunity to record his preferences and thereby edit the playlist (step 73). However, all of the usage and tracking data relating to the user is also tracked (step 74) and presented to the programmer, so that the programmer may make a decision as to whether a track should be added or dropped from the playlist. For example, a listener to a station may be skipping tracks, searching in a search engine for the name of an artist whose music does not fit the genre for the station, and searching for and listening to tracks and artists which are not on the station. A number of listeners to the station may also be performing the same or similar actions. These actions are tracked and aggregated and presented to the programmer (step 75), with a list of tracks and artists extracted. The programmer may then modify the playlist in accordance with rules governing the station (e.g. “Classical station—Rule 1: No disco music”) and make a final determination whether a track or artist should be added to or deleted from the station (step 76).

The audio and/or video content presented on the stations may include advertising as well as editorial content. In an embodiment, advertising may be inserted into the initial playlist for a station. Furthermore, advertisements may be included in the list of recommended media content items displayed to the user.

In accordance with the disclosure, online radio and television stations may become more relevant to their customers, since the actual consumers of the media content perform the programming and thus control the content presented by the station.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

We claim:

1. A method comprising:
creating an initial playlist for an online media station;
creating a set of recommended media content items distinct from the initial playlist;
aggregating user input regarding the recommended media content items; and
generating a new playlist in accordance with the aggregated input, wherein
the user input regarding a given item of media content includes a positive vote or a negative vote, and
each item of the new playlist has an aggregated positive vote greater than a predetermined vote threshold.

2. A method according to claim 1, wherein the user input includes
a first type of input causing play of a selected content item in place of currently playing content, associating a positive vote with said selected item, and associating a negative vote with said currently playing content;
a second type of input causing play of a selected content item immediately subsequent to play of currently playing content, and associating a positive vote with said selected item; and
a third type of input associating a negative vote with a content item.

3. A method according to claim 1, further comprising:
creating a new set of recommended media content items in response to the user input.

4. A method according to claim 1, further comprising:
creating a new set of recommended media content items in response to an input from an individual user; and
establishing said new set as the new playlist of a station for that individual user.

5. A method according to claim 2, further comprising:
causing display of identifiers for the set of recommended media content items at a computing device of the user; and
causing display of actionable areas associated with said content items for making the first, second and third types of input.

6. A method according to claim 1, wherein said users include members of a predefined group, and input is aggregated only from said members.

7. A method according to claim 1, further comprising:
modifying the new playlist in accordance with predetermined rules relating to the station.

8. A method according to claim 6, further comprising:
tracking online actions by a user; and
reporting said actions to a programmer for the station.

9. A system comprising:
a server configured to
create an initial playlist for an online media station;
create, using a recommendation engine and a database of media content items, a set of recommended media content items distinct from the initial playlist;
aggregate user input regarding the recommended media content items; and
generate a new playlist in accordance with the aggregated input, wherein
the user input regarding a given item of media content includes a positive vote or a negative vote, and
each item of the new playlist has an aggregated positive vote greater than a predetermined vote threshold.

10. A system according to claim 9, wherein the server is configured to
cause play of a user-selected content item in place of currently playing content at a computing device of the user, associate a positive vote with said user-selected item, and associate a negative vote with said currently playing content, in response to a first type of user input;
cause play of a user-selected content item immediately subsequent to play of currently playing content at a computing device of the user, and associate a positive vote with said user-selected item, in response to a second type of user input; and
associate a negative vote with a content item in response to a third type of user input.

11. A system according to claim 9, wherein the server is configured to
create a new set of recommended media content items in response to the user input.

12. A system according to claim 9, wherein the server is configured to
create a new set of recommended media content items in response to an input from an individual user; and
establish said new set as the new playlist of a station for that individual user.

13. A system according to claim 9, wherein the server is configured to
cause display of identifiers for the set of recommended media content items at a computing device of the user; and
cause display of actionable areas associated with said content items for making the first, second and third types of input.

14. A system according to claim 9, wherein the server is configured to
recognize members of a predefined group in a plurality of users, and aggregate input only from said members.

15. A system according to claim 9, wherein the server is configured to
track online actions by a user;
present a report of said actions to a programmer for the station; and
modify the new playlist in accordance with a determination by the programmer.

16. A computer-readable medium having stored therein instructions for performing a method comprising:
creating an initial playlist for an online media station;
creating a set of recommended media content items distinct from the initial playlist;
aggregating user input regarding the recommended media content items; and
generating a new playlist in accordance with the aggregated input, wherein
the user input regarding a given item of media content includes a positive vote or a negative vote, and
each item of the new playlist has an aggregated positive vote greater than a predetermined vote threshold.

17. A computer-readable medium according to claim 16, wherein the user input includes
a first type of input causing play of a selected content item in place of currently playing content, associating a positive vote with said selected item, and associating a negative vote with said currently playing content;
a second type of input causing play of a selected content item immediately subsequent to play of currently playing content, and associating a positive vote with said selected item; and
a third type of input associating a negative vote with a content item.

18. A computer-readable medium according to claim 16, wherein the method further comprises:
creating a new set of recommended media content items in response to the user input.

19. A computer-readable medium according to claim 16, wherein the method further comprises:
creating a new set of recommended media content items in response to an input from an individual user; and
establishing said new set as the new playlist of a station for that individual user.

20. A computer-readable medium according to claim 16, wherein the method further comprises:
causing display of identifiers for the set of recommended media content items at a computing device of the user; and
causing display of actionable areas associated with said content items for making the first, second and third types of input.

21. A computer-readable medium according to claim 16, wherein the method further comprises:
recognizing members of a predefined group in a plurality of users; and
aggregating input only from said members.

22. A computer-readable medium according to claim 16, wherein the method further comprises
tracking online actions by a user;
reporting said actions to a programmer for the station; and
modifying the new playlist in accordance with a determination by the programmer.

23. A user interface comprising:
a first area for displaying identifiers for a set of recommended media content items; and
a second area including buttons for user input regarding the recommended media content items, wherein
the interface relates to an online media station,
the set of recommended media content items is distinct from an initial playlist of the station, and
the buttons are effective to record positive votes and negative votes regarding the media content items.

24. A user interface according to claim 23, wherein the buttons include
a first type of button for making input causing play of a selected content item in place of currently playing content, associating a positive vote with said selected item, and associating a negative vote with said currently playing content;
a second type of button for making input causing play of a selected content item immediately subsequent to play of currently playing content, and associating a positive vote with said selected item; and
a third type of button for making input associating a negative vote with a content item.

25. A user interface according to claim 23, wherein the buttons include
a button for making input to create a new set of recommended media content items and establish said new set as a new playlist of a station for an individual user.
